(19) United States
(12) Patent Application Publication
(10) Pub. No.: US 2007/0078893 A1
(43) Pub. Date: Apr. 5, 2007

(54) Automated project management method

(76) Inventor: Eric Milhet, Meylan (FR)

Correspondence Address: CATERPILLAR/FINNEGAN, HENDERSON, L.L.P., 901 New York Avenue, NW, WASHINGTON, DC, 20001-4413, US

(21) Appl. No.: 11/239,242

(22) Filed: Sep. 30, 2005

(51) Int. Cl. G06F 7/00

(52) U.S. Cl. 707/104.1

(57) ABSTRACT

A software implemented method and user interface for managing development of products including machine components are disclosed. The method may include opening a record adapted to store design data associated with a machine component, receiving a first portion of the design data from a designer, receiving verification of the first portion of the design data from a first analyst, and receiving a second portion of the design data associated with the machine component from the first analyst. The method may further include sending the verified first portion of the design data and the second portion of the design data to a second analyst as a work order, receiving updates from the second analyst on work performed in response to the work order, and reporting progress on work performed based on the updates.

### TECHNICAL FIELD

The present disclosure relates to an automated project management method and user interface, and, more particularly, a project management application for automatically generating and tracking resources and data associated with a product development.

### BACKGROUND

Project managers and developers may coordinate and track design activities, schedules, design data, costs, and other data using project management software. A project may be, for example, development of a new work machine, such as a bulldozer. Development of a bulldozer may include development of several machine components, such as a blade, a winch, an engine, etc. Design of each component may be assigned to separate teams and separate subcontractors to expedite development and increase efficiency. However, the requirements and development schedule for each machine component must be closely managed to ensure each component is developed in a timely manner and operates successfully when assembled as a system. Moreover, multiple users need access to the same data in real time in order to carry out their development functions.

In order to successfully design and develop a project, such as a work machine, designers and analysts often create a simulation or model known as a Finite Element Analysis (FEA) for a particular work machine component to predict the component's behavior under various different stresses and situations. An FEA often requires detailed planning and input of data from various parties to avoid a risk of failure when the work machine is assembled and to ensure that the work machine will meet overall design constraints.

At least one system is known for managing projects and their resources. For example, U.S. Pat. No. 6,678,671 (“the '671 patent”) to Petrovic et al. dated Jan. 13, 2004, describes a system for linking resource data, such as facilities, people, and expenses within a resource management system, to events of a project contained in a project management system using a database. For example, a resource can be attached to an event and can be managed within a project. The resources can also be managed in a booking system independent of any projects. This allows both project and resource managers to manage resources. The system generates reports, such as Gantt charts, containing events and their associated resource data, and Staff Capacity charts, containing status of work performed and percentage workloads for individual staff members.

While the method and system of the '671 patent may be effective for linking resource data with project events, the system of the '671 patent includes several disadvantages. For example, the method and system of the '671 patent do not request or store design data associated with a project. Moreover, the method and system of the '671 patent are passive. For example, the system does not actively provide reminders to users requesting the entry and updating of data by certain deadlines, nor does it actively define for users what data should be provided.

The present disclosure is directed to overcoming one or more of the problems or disadvantages existing in the prior art.

### SUMMARY OF THE INVENTION

One disclosed embodiment includes a method for managing development of products including machine components. The method may include opening a record adapted to store design data associated with a machine component, receiving a first portion of the design data from a designer, receiving verification of the first portion of the design data from a first analyst, and receiving a second portion of the design data associated with the machine component from the first analyst. The method may further include sending the verified first portion of the design data and the second portion of the design data to a second analyst as a work order, receiving updates from the second analyst on work performed in response to the work order, and reporting progress on work performed based on the updates.

A second disclosed embodiment includes a user interface for managing development of machine components. The user interface may provide several options. For example, the user interface may provide an option for creating records adapted to store design data associated with machine components used in a product. Other options provided may include an option for inputting data in the records to create work orders, an option for displaying a status of the records, and an option for creating analyst records describing analysts designated to respond to the work orders. The user interface may further provide an option for creating product records describing products utilizing the machine components, an option for displaying statistics describing progress associated with the work orders, and an option for displaying schedules associated with the work orders. In addition the user interface may provide an option for displaying costs associated with the work orders, and an option for archiving the records adapted to store the design data and results of work performed by analysts.

### BRIEF DESCRIPTION OF THE DRAWINGS

FIG. 1 provides an exemplary main user interface presented by a disclosed project management application.

FIG. 2 provides an exemplary engineering user interface presented by the disclosed project management application.

FIG. 3 provides a flow chart of an exemplary method that may be performed by the disclosed project management application.

FIGS. 4A-4D provide exemplary FEA record interfaces presented by selecting an FEA management option from the exemplary engineering user interface of FIG. 2.

FIG. 5 provides an exemplary reminder screen presented by the disclosed project management application.

FIG. 6 provides an exemplary logon interface presented by selecting an FEA checklist option available from the exemplary engineering user interface of FIG. 2.

FIG. 7 provides an exemplary designer interface associated with the FEA checklist option.

FIG. 8 provides an exemplary analyst interface associated with the FEA checklist option.

FIGS. 9A through 9D are exemplary views of designer and analyst checklist interfaces associated with the FEA checklist option.

FIG. 10 is an exemplary work order screen associated with the FEA checklist option.

FIG. 11 is an exemplary schedule screen presented by selecting a schedule option available from the exemplary engineering user interface of FIG. 2.

FIG. 12 is an exemplary statistics report screen presented by selecting a statistics option available from the exemplary engineering user interface of FIG. 2.

FIGS. 13A-13C are exemplary user interfaces associated with a tool option available in the exemplary engineering user interface of FIG. 2.

FIG. 14 is an exemplary cost report screen presented by selecting a cost option available from the exemplary main user interface of FIG. 1.

### DETAILED DESCRIPTION

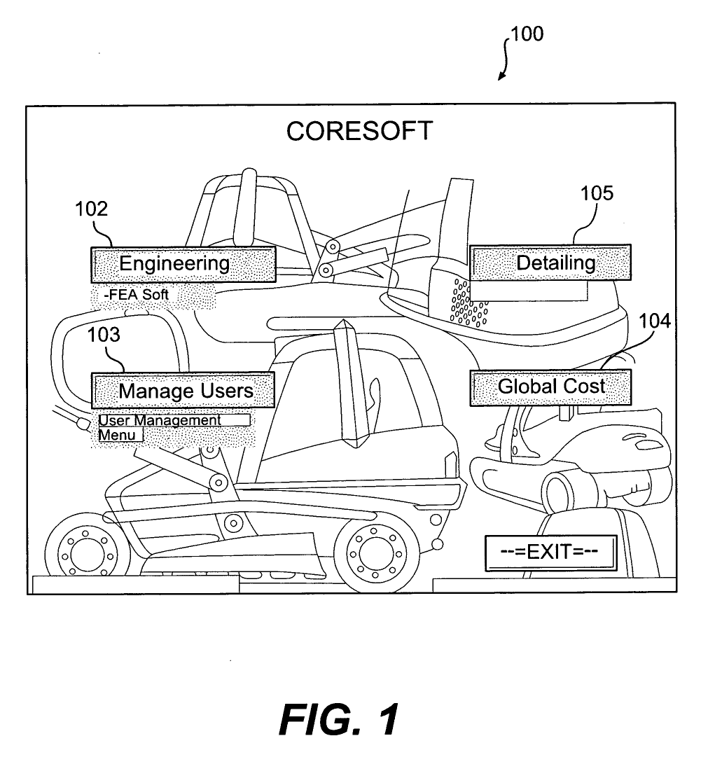

FIG. 1 is a main user interface 100 presented by a project management application for managing development of products including machine components. Main user interface 100 may be a first screen presented to a user upon launching the product management application. Main user interface 100 may include various selectable options such as an engineering option 102, a user management option 103, a detailing option 105, and a cost option 104. Users of the project management application may include team leaders, designers, analysts, and subcontractors. Subcontractors may also be analysts, but may work for an organization external to one that produces design requirements for the products under development. Users may create a new or edit existing product design records (e.g., FEA records) by selecting engineering option 102.

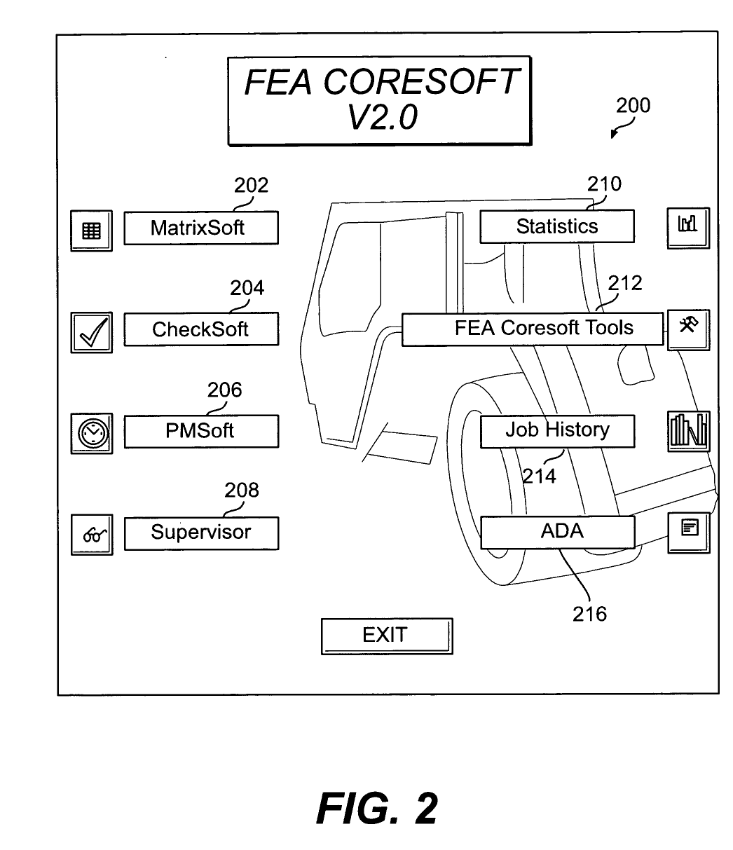

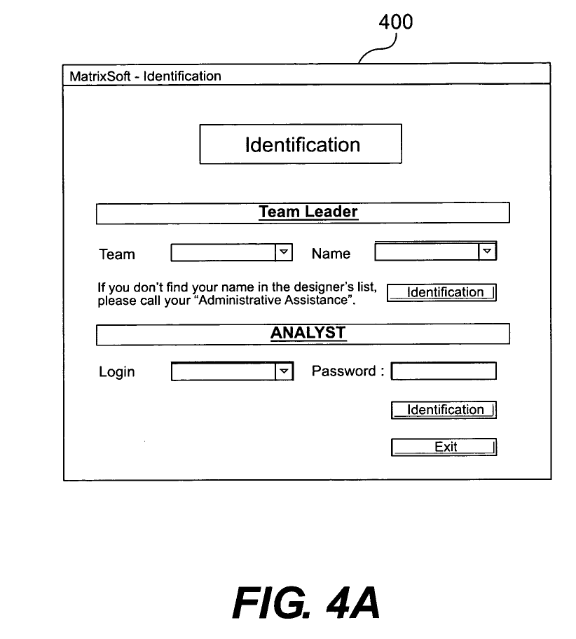

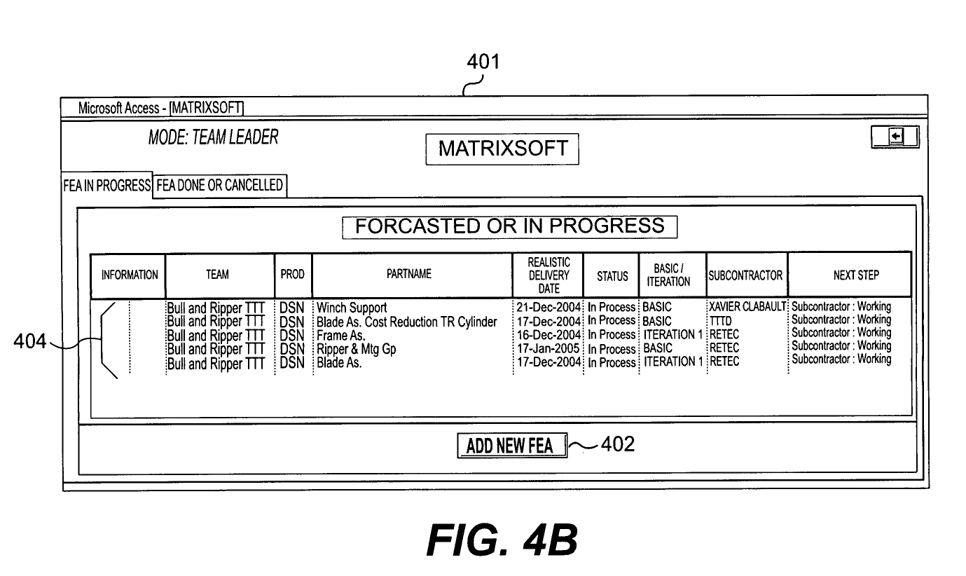

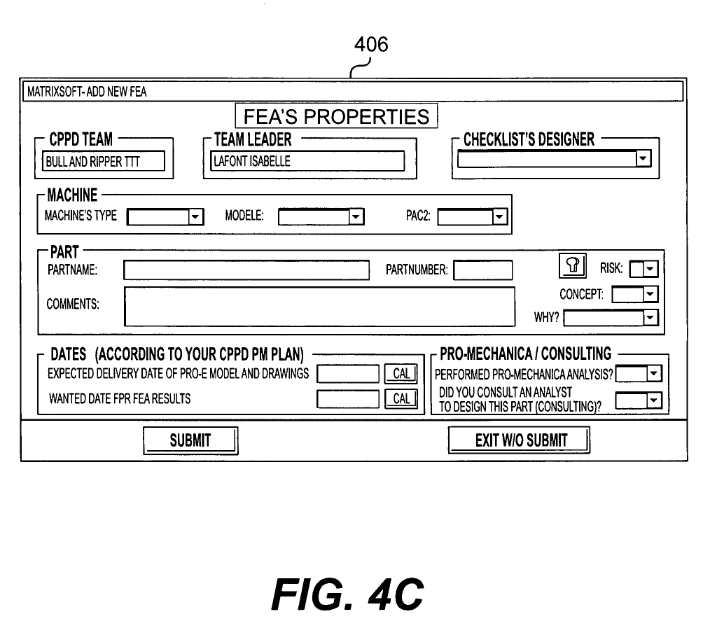

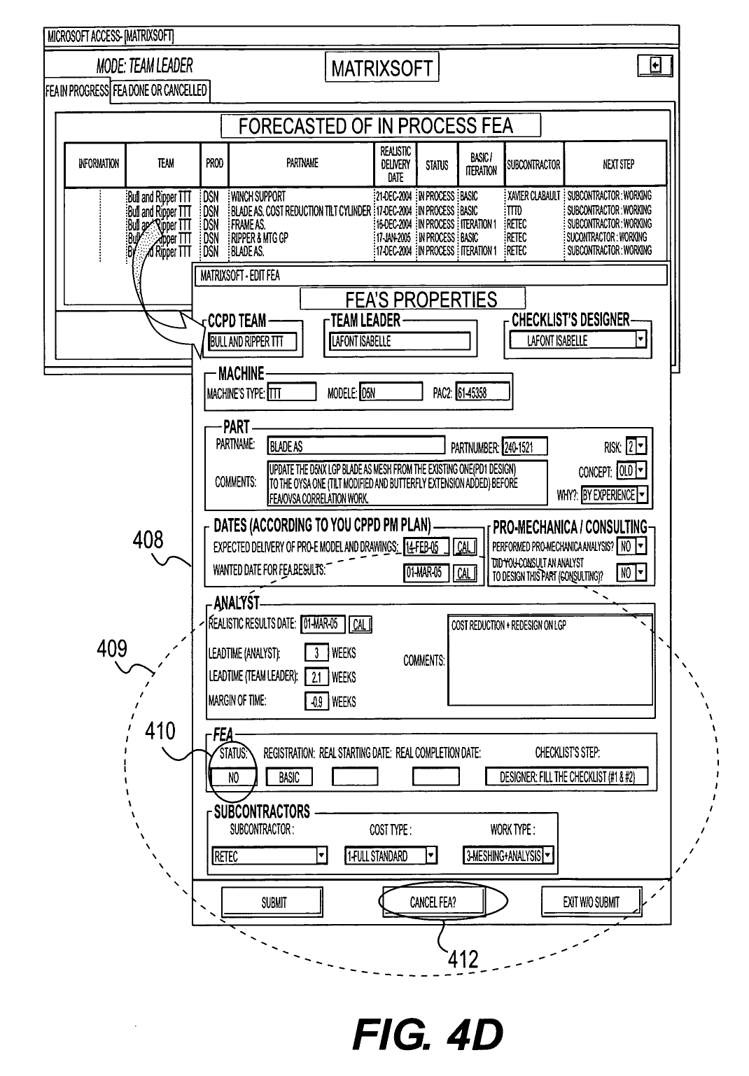

FIG. 2 is an engineering user interface 200 presented by the product management application if a user selects engineering option 102 from main user interface 100. Engineering user interface 200 may include various selectable options such as an FEA management option 202 (MatrixSoft), an FEA checklist option 204 (CheckSoft), a schedule option 206 (PMSoft), a supervisor option 208, a statistics option 210, a tool option 212 (FEA Coresoft Tools), a job history option 214, and an analysis data archive option 216 (ADA). Selecting supervisor option 208 may bring up an interface for a supervisor (e.g., team leader) to track work done by designers and analysts. Selecting job history option 214 may bring up an interface for searching through records associated with completed product designs (e.g., old work orders, cost records, statistics, etc.). Selecting analysis data archive option 216 (ADA) may bring up an interface for archiving and for searching archived FEA results (e.g., performance and structural analysis data). Interfaces and functions associated with FEA management option 202 (MatrixSoft), FEA checklist option 204 (CheckSoft), schedule option 206 (PMSoft), statistics option 210, and tool option 212 (FEA Coresoft Tools) are explained below with reference to FIGS. 4A-15. Screens and user interfaces of FIGS. 4A-15 contain fields that are filled in with values that are only exemplary.

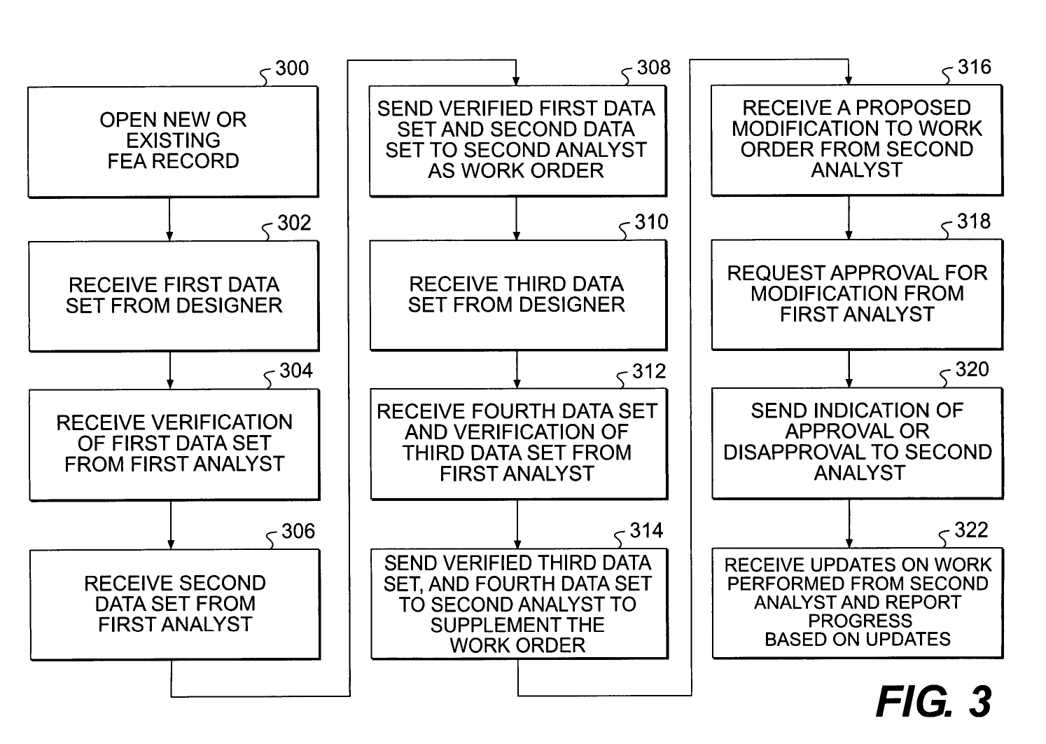

FIG. 3 is a flowchart view depicting a method carried out by the product management application. Through engineering user interface 200, a designer may open an FEA record to store design data associated with a work machine component under development. Opening an FEA record may be accomplished by creating a new FEA record or accessing an existing FEA record for editing (stage 300). The design data may be entered, edited, or viewed by designers and analysts, and may be viewed by subcontractors. FIGS. 4A-4D, explained below, are exemplary screens associated with entering, editing, or viewing design data in FEA records.

FIG. 4A is an exemplary FEA management logon interface 400 presented by the product management application if the user selects FEA management option 202 (MatrixSoft) from engineering user interface 200 shown in FIG. 2. Users may logon as team leaders or analysts.

FIG. 4B is an exemplary FEA management interface 401 presented by the product management application if the user logs on as a team leader using FEA management logon interface 400 in FIG. 4A. Using an add new FEA option 402 in FEA management interface 401, the team leader can add new and edit existing FEA records 404.

FIG. 4C is an exemplary add new FEA record interface 406 presented by the product management application if the team leader selects add new FEA option 402 (MatrixSoft) from FEA management interface 401. A new FEA record may be associated with a particular machine component (i.e., part) of a product under development. Add new FEA record interface 406 may be divided into various sections, including a machine properties section, a part properties section, and a dates section, among others. The team leader may define data associated the particular machine component in each of the various sections. Data associated with the particular machine component may include a part name, a part number, an associated machine type and model, a team name, a team leader, a checklist designer, a risk level, expected delivery dates for models, drawings, and FEA results, as well as additional comments and identifying information. A field for checklist designer may designate a person to enter design data in a checklist associated with an FEA record 404. For example, the design data may later be entered using FEA checklist option 204 (CheckSoft) available from engineering user interface 200 shown in FIG. 2.

FIG. 4D is an exemplary edit existing FEA record interface 408 presented by the product management application if a user logs on as an analyst using FEA management logon interface 400 (FIG. 4A) and selects an existing FEA record from FEA management interface 401 (FIG. 4B). Using edit existing FEA record interface 408, the analyst may add data associated with a machine component under development. For example, the existing FEA record may include analyst sections 409 that are not shown in add new FEA record interface 406 of FIG. 4B.

If design data associated with the existing FEA record has been entered through FEA checklist option 204 (CheckSoft) and sent to a subcontractor, a status field 410 in edit existing FEA record interface 408 may be changed from “no” to “in process.” If status field 410 indicates “in process” a cancel FEA option 412 may be disabled. This may be done to ensure that a subcontractor has completed a work order (e.g., performed a requested analysis) associated with the existing FEA record before it is cancelled. Status field 410 may indicate “cancelled” if the existing FEA record has been cancelled. Status field 410 may also indicate “done” if a subcontractor has completed the requested analysis associated with the existing FEA record. In addition, if the status of an existing FEA record is “done,” an analyst may request a single iteration analysis based on the completed analysis since much of the data required for a single iteration analysis will be the same.

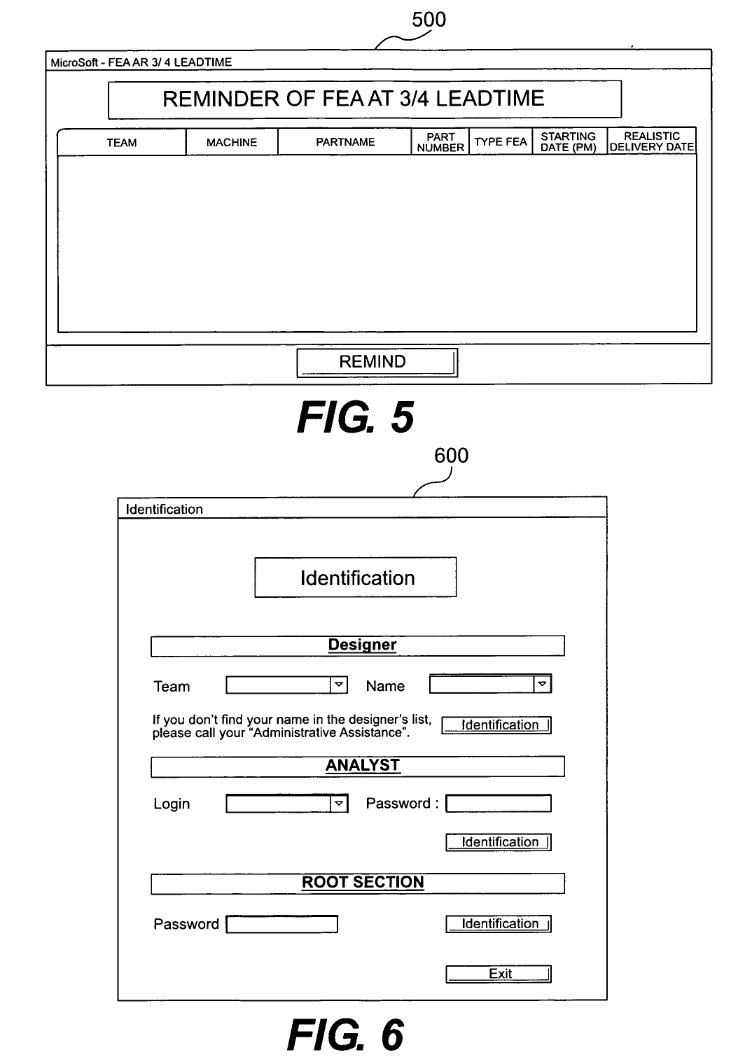

FIG. 5 is an exemplary reminder screen 500 presented by the product management application to remind designers or analysts of an approaching deadline. For example, based on schedule data entered in an FEA record, a designer may receive a reminder from the product management application (e.g., as an email) to enter design data in a checklist. In addition, analysts may receive reminders to verify design data in a checklist after it has been entered. Analysts may also receive reminders if subcontractors are late in responding to a work order. The reminder may request that an email be sent to the subcontractor requesting a response to the work order.

FIG. 6 is a checklist logon interface 600 presented by the product management application if the user selects FEA checklist option 204 (CheckSoft) from engineering user interface 200. Users may logon as designers or analysts. In addition, a root logon may also be provided for administrative users, such as system managers.

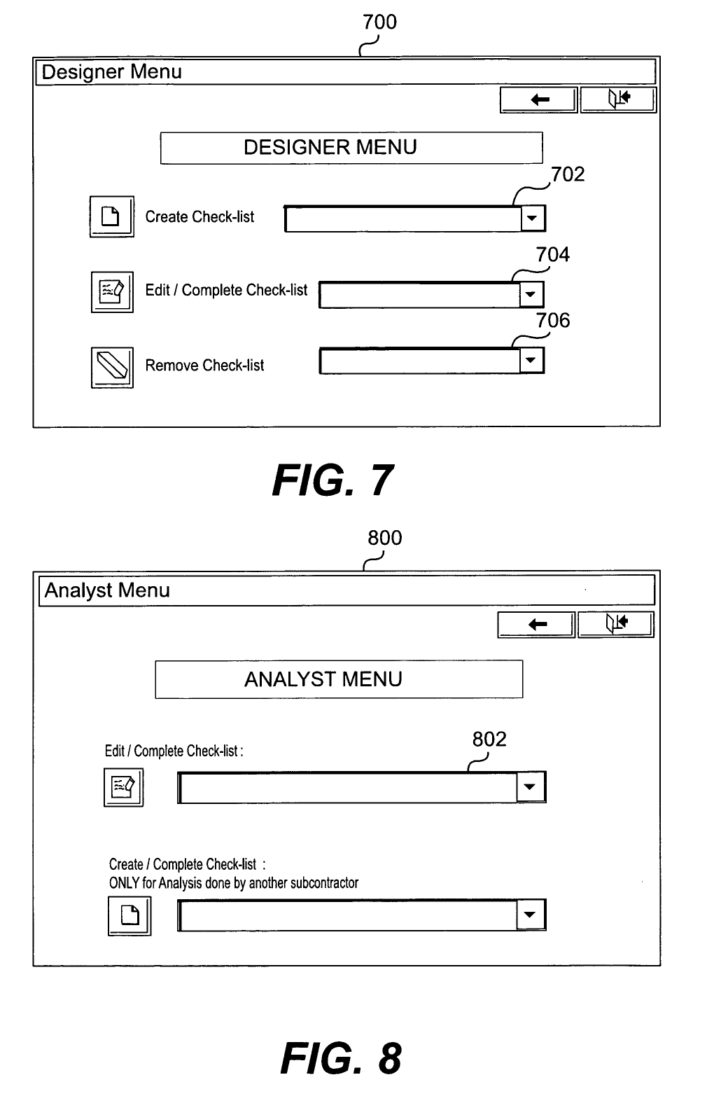

FIG. 7 is a designer interface 700 presented by the product management application if the user logs in as a designer using checklist logon interface 600. Designer interface 700 may present a create checklist option 702, an edit/complete checklist option 704, and a remove checklist option 706.

FIG. 8 is an analyst interface 800 presented by the product management application if a user logs in as an analyst on checklist logon interface 600. Analyst interface 800 may present an edit/complete checklist option 802, among other options.

Referring again to the method in FIG. 3, the designer may enter data in a checklist and the product management application may receive the data as a first data set (stage 302). For example, the designer may logon as a designer using checklist logon interface 600 and may select create checklist option 702 or edit/complete checklist option 704 to enter data in the first data set.

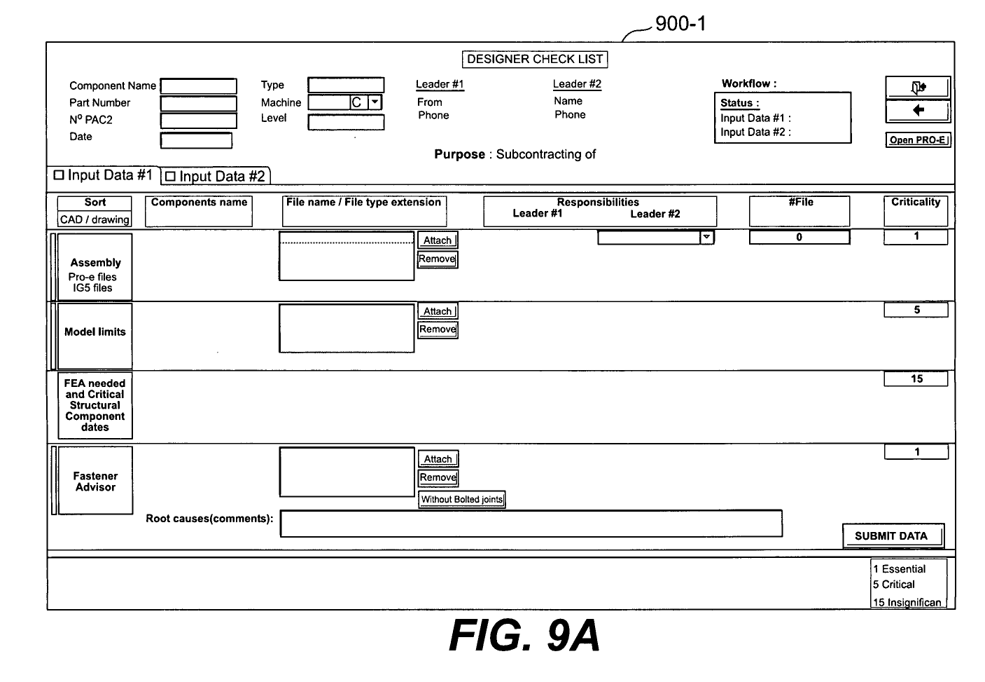

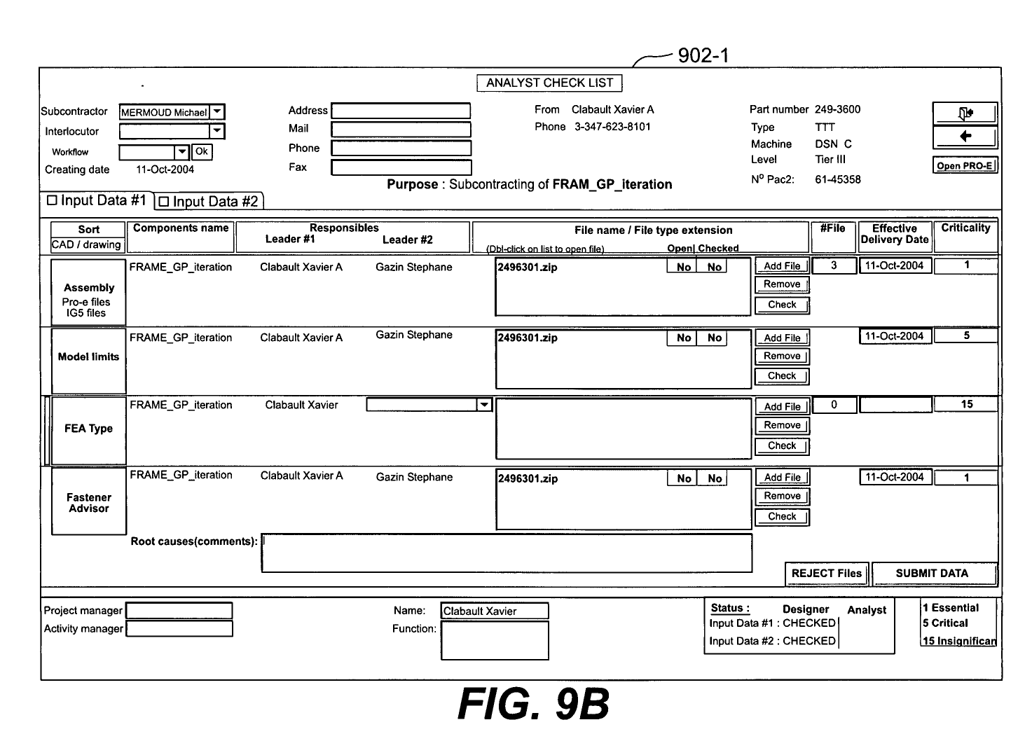

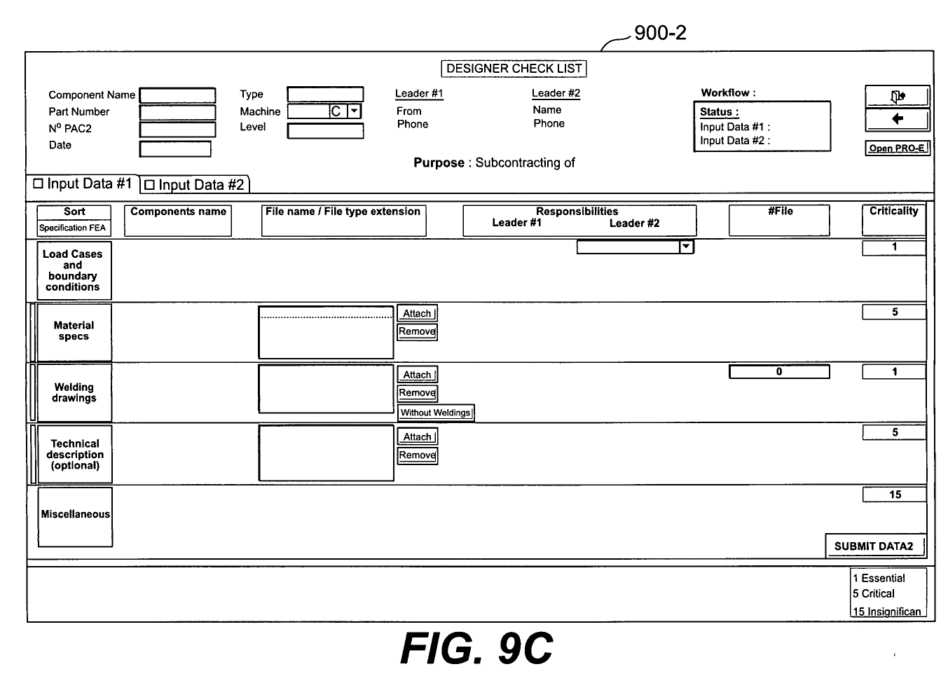

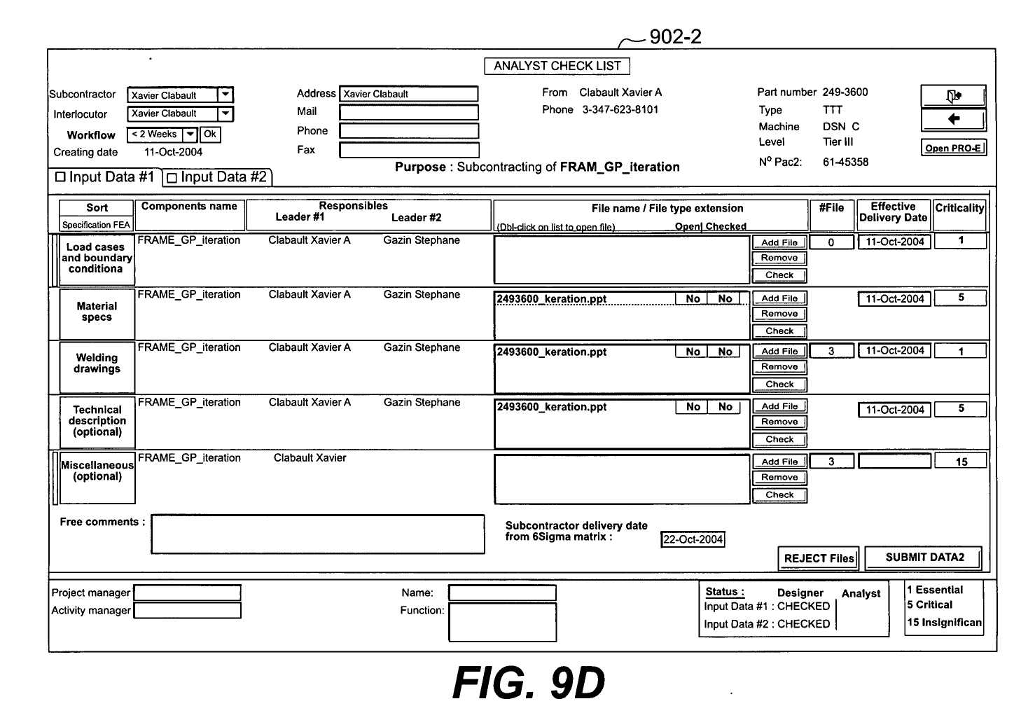

FIGS. 9A through 9D are exemplary views of checklist interfaces presented to designers and analysts who log in through checklist logon interface 600. Reference will now be made to these figures and to FIG. 3 to describe stages 304 through 322 of FIG. 3.

FIG. 9A is an exemplary first view of designer checklist interface 900-1 for prompting the designer to enter the first data set. First view of designer checklist interface 900-1 may be presented if the designer selects create checklist option 702 from designer interface 700. First view of designer checklist interface 900-1 may present the designer with blank fields highlighted in yellow, prompting the designer to enter data associated with a work machine component in the highlighted blank fields. Data entered in the first data set may include drawings (e.g., pro-e files or IGS files), model limits (i.e., constraints), and fastener information associated with the work machine component.

Referring again to the method in FIG. 3, the first analyst may verify the first data set by opening the associated files, reviewing the data submitted by the designer, and indicating that the data has been reviewed (stage 304). The first analyst may also enter data in a second checklist as a second data set (stage 306). For example, the first analyst may logon as an analyst using checklist logon interface 600 and may select edit/complete checklist option 802 to verify the first data set and enter data in the second data set.

FIG. 9B is an exemplary first view of first analyst checklist interface 902-1 for prompting the first analyst to verify the first data set and to enter the second data set. First view of first analyst checklist interface 902-1 may be presented if the first analyst selects edit/complete checklist option 802 from analyst interface 800. The first analyst may be presented with selectable yes/no options corresponding to the various files in the first data set. Thus, the first analyst may indicate that files have been opened and the data within has been checked or reviewed by selecting yes. The first analyst may also be presented with blank fields highlighted in yellow, prompting the first analyst to enter data associated with a work machine component in the highlighted blank fields. Data entered in the second data set may include a tentative work schedule, a backup analyst, an interlocutor (i.e., a subcontractor point of contact), and an FEA type (e.g., G-load, modal, fatigue, transient, etc.).

Referring again to the method in FIG. 3, the first analyst may then a select an option to submit the verified first data set and the second data set. In response, the product management application may automatically send an email to a second analyst containing the verified first data set and the second data set as a work order (stage 308). For example, the product management application may compress and email the various files in the first and second data sets together with a work order form (i.e., a technical proposal) requesting confirmation of the tentative schedule and verification of data in the first and second data sets. The second analyst may be a subcontracted analyst (i.e., subcontractor) who works for an organization external to one that the designer and first analyst work for. Alternatively, the second analyst may work for the same organization, in which case the product management application may inform the second analyst by email of a directory location for finding the verified first data set and the second data set. Before receiving feedback from the second analyst, the product management application may receive data in a third checklist as a third data set from the designer (stage 310).

FIG. 9C is an exemplary second view of designer checklist interface 900-2 for prompting the designer to enter the third data set. Similar to first view of designer checklist interface 900-1, the designer may be presented with highlighted blank fields in second view designer checklist interface 900-2 for prompting the designer to enter certain data. Data entered in the third data set may include material specifications or properties (e.g., tensile strength, yield strength, and Young modulus), welding drawings (e.g., length, size, quality of weld joints), and a technical description. After entering data for the third data set, the designer may select an option to submit the third data set and the product management application may automatically send an email to the first analyst requesting verification of the third data set.

Referring again to the method in FIG. 3, the first analyst may verify the third data set by opening the files and reviewing the data submitted by the designer and indicating that it has been reviewed (stage 312). At this point, the first analyst may also enter data in a fourth checklist as a fourth data set (stage 312).

FIG. 9D is an exemplary second view of first analyst checklist interface 902-2 for prompting the first analyst to verify the third data set and enter the fourth data set. Similar to the exemplary first view of first analyst checklist interface 902-1, the first analyst may be presented in the exemplary second view with selectable yes/no options corresponding to the various files in the third data set and may also be presented with highlighted blank fields, prompting the first analyst to enter certain data. Data entered in the fourth data set may include information such as load cases, boundary conditions, miscellaneous data, and comments. The first analyst may then a select an option to submit the verified third data set and the fourth data set.

Referring again to the method in FIG. 3, the product management application may automatically send an email to the second analyst indicating a directory location or containing the verified third data set and the fourth data set as a supplement to the previously sent work order (stage 314). Alternatively, stage 308 may be skipped and an email containing or indicating a directory location of the verified first data set, the second data set, the verified third data set, and the fourth data set may be sent as a work order at stage 314.

After the second analyst has received the work order, the second analyst may verify receipt of the work order and may propose a predicted number of hours required to fulfill the work order or modifications to the data sets. The proposals may be received by the product management application (stage 316) and approval from the first analyst may be requested (stage 318). The first analyst may approve of the proposals and an indication of the approval may be sent to the second analyst (stage 320). If the first analyst does not approve, he may indicate reasons for disapproval and send them to the second analyst (stage 320). The process may continue until an agreement is reached and work is commenced. After commencing work, the second analyst may periodically send updates on progress, which may be recorded by the product management application. The product management application may provide progress reports in various formats based on the updates received from the second analyst (stage 322).

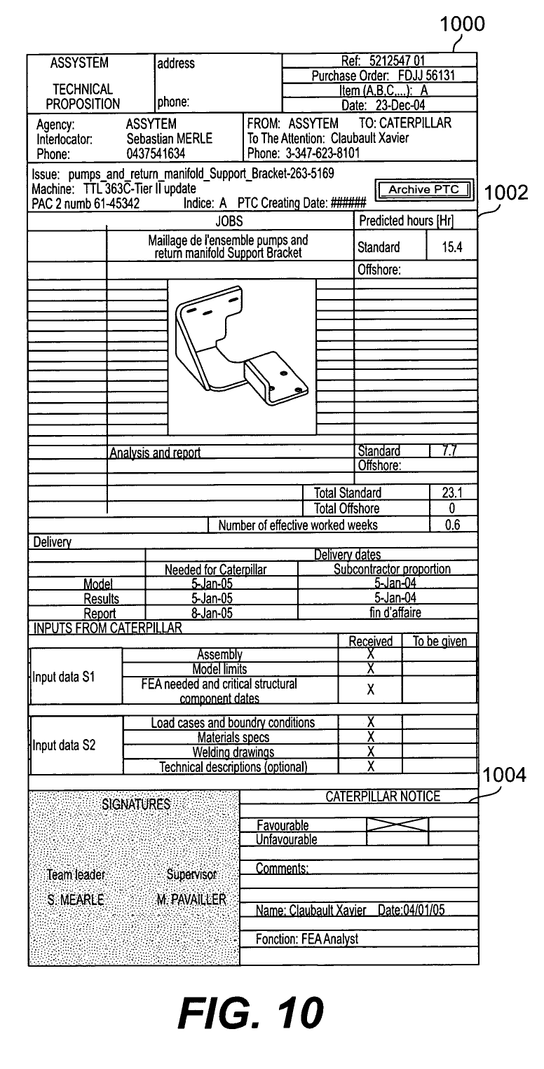

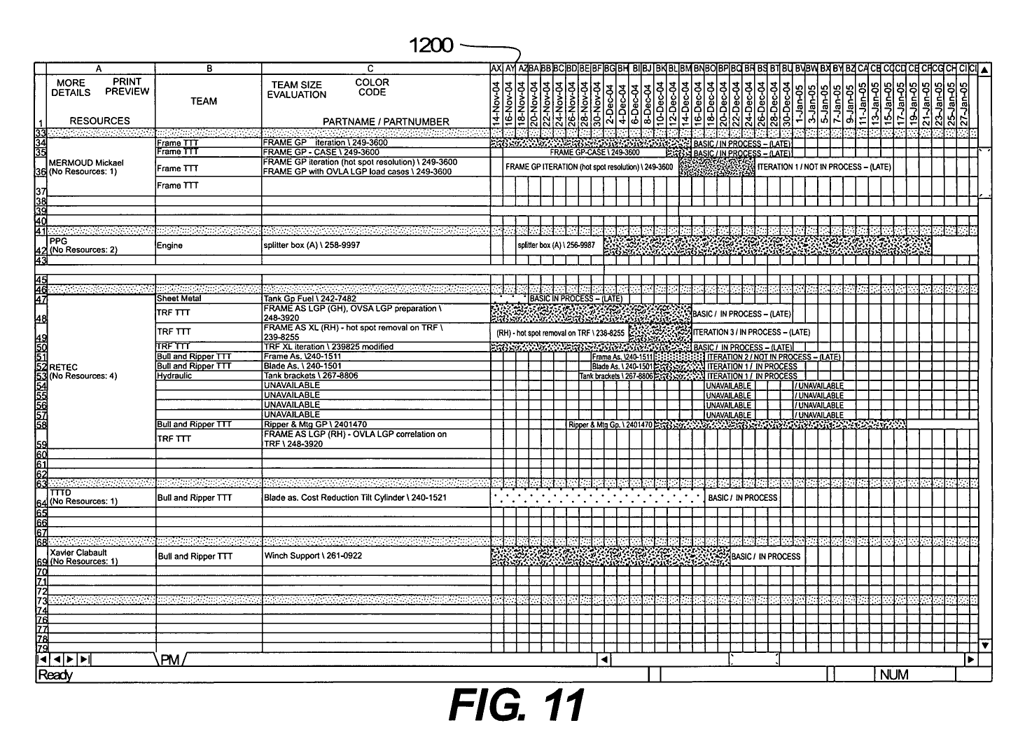

FIG. 10 is a work order screen 1000 sent to the second analyst (e.g., a subcontractor) by the product management application after completion of the checklists. The second analyst may propose a number of hours required to complete the requested work in predicted hours column 1002. The first analyst may indicate approval or disapproval of the proposals in notice block 1004.

The product management application may also allow for separate subcontractors to perform the meshing and the analysis associated with an FEA of a work machine component. For example, the second analyst (e.g., subcontractor A) may produce a meshing, and a third analyst (e.g., subcontractor B) may perform an FEA based on the meshing.

FIG. 11 is a schedule screen 1200 presented by the product management application if a user selects schedule option 206 (PMSoft) from engineering user interface 200. Team leaders, analysts, and designers may view schedule screen 1200 to review progress and manage resources. Schedule screen 1200 may be formatted as a spreadsheet listing machine components (i.e., parts) resources along a left column and dates along a top row. Resources, such as subcontractors and development teams, assigned to develop individual machine components may also be listed along the left column of schedule screen 1200. Authorized users may update data in schedule screen 1200 based on updates from subcontractors.

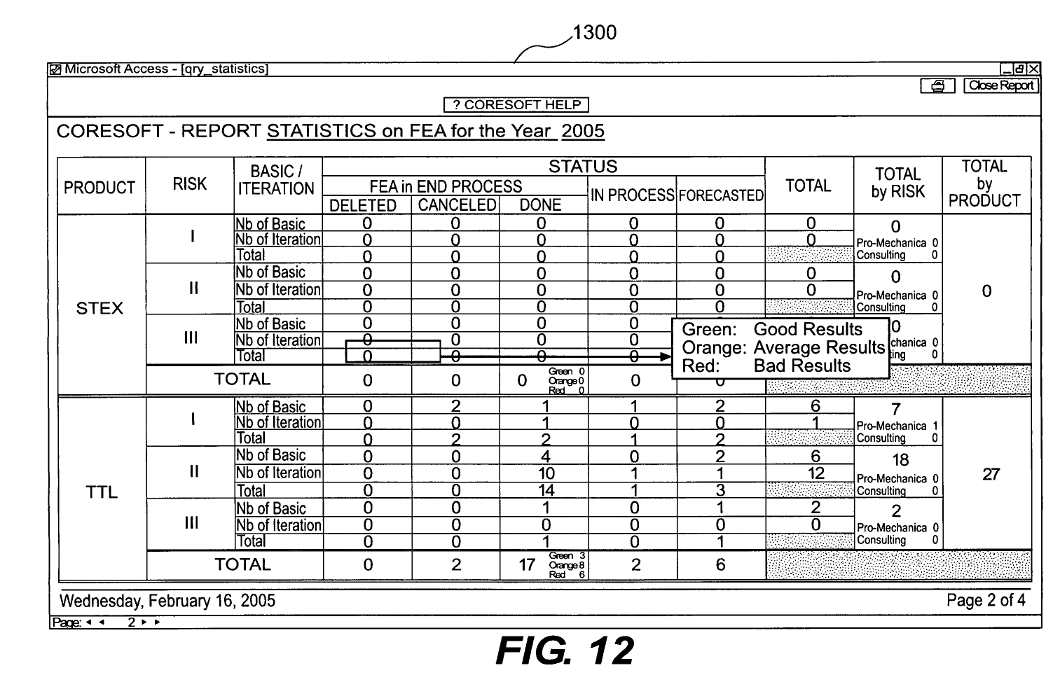

FIG. 12 is a statistics report screen 1300 presented by the product management application if the user selects statistics option 210 from engineering user interface 200. Team leaders, analysts, and designers may view statistics report screen 1300 to review and compare progress and risk levels of various FEA projects associated with work machine components. Authorized users may update data in statistics report screen 1300 based on updates from subcontractors.

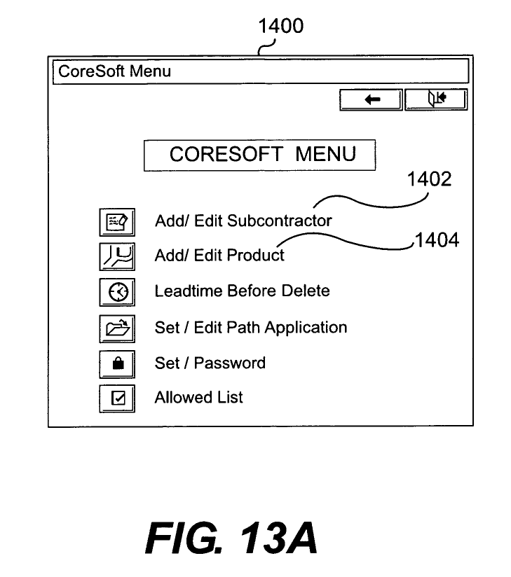

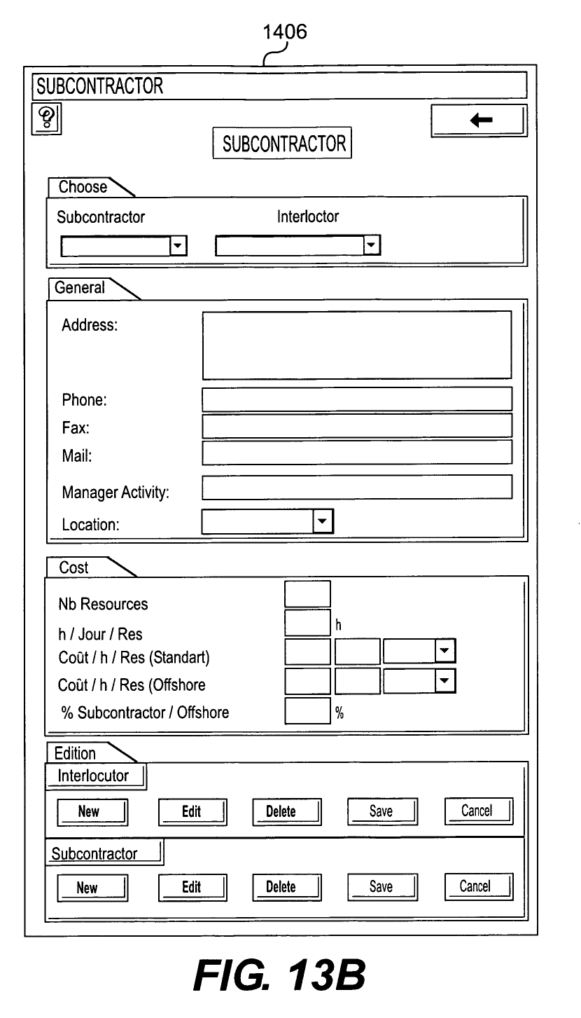

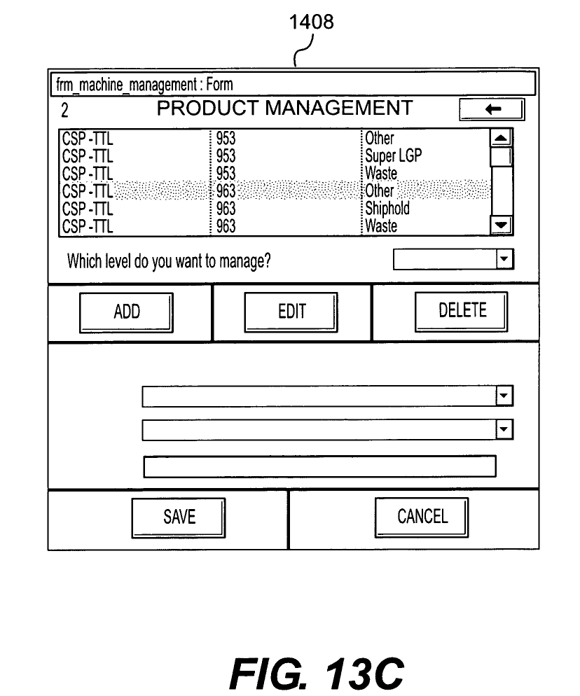

FIGS. 13A-13C show interfaces presented by the product management application if the user selects tool option 212 (FEA Coresoft Tools) from engineering user interface 200. FIG. 13A is a tool option interface 1400 presented by the product management application after the user selects tool option 212 (FEA Coresoft Tools). The user may then select various options from tool option interface 1400, including an add/edit subcontractor option 1402, and an add/edit product option 1404.

FIG. 13B is an add/edit subcontractor interface 1406 presented by the product management application if the user selects add/edit subcontractor option 1402 from tool option interface 1400. Using add/edit subcontractor interface 1406, the user may add, edit, or delete a subcontractor record. A subcontractor record may include contact information, number of resources, cost information, and interlocutor (i.e., point of contact) information.

FIG. 13C is an add/edit product interface 1408 presented by the product management application if the user selects add/edit product option 1404 from tool option interface 1400. Using add/edit product interface 1408, the user may add, edit, or delete a product record. A product record may include information describing a product, such as a work machine under development.

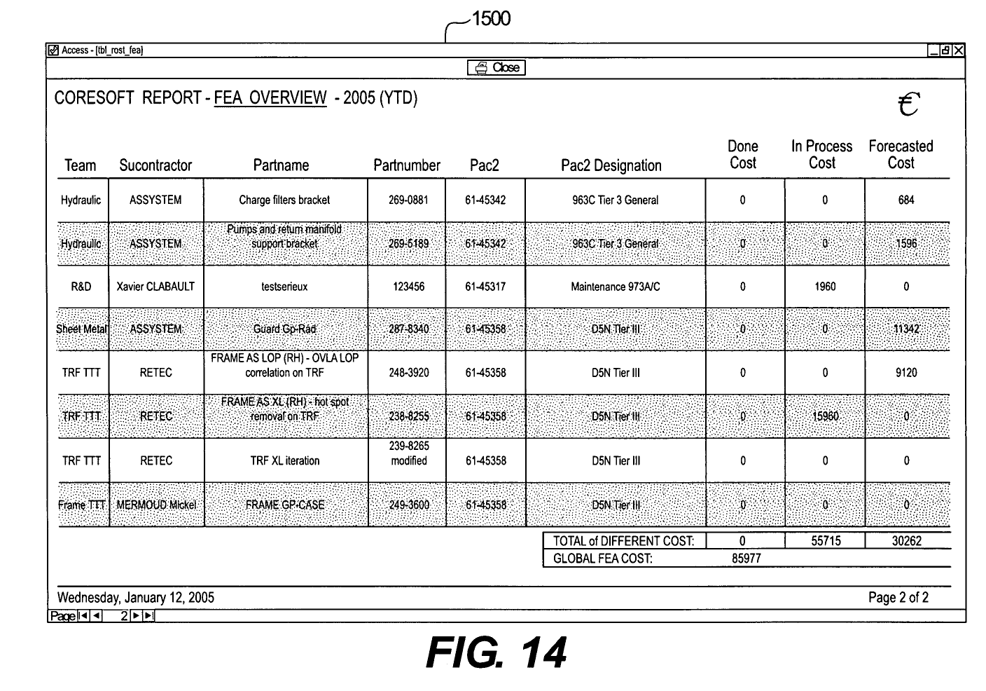

FIG. 14 is a cost report screen 1500 presented by the product management application if the user selects cost option 104 (Global Cost) from main user interface 100. Team leaders, analysts, and designers may view cost report screen 1500 to review and compare paid costs, in-process costs, and forecasted costs of various FEA projects associated with work machine components. Cost report screen 1500 may report costs in different user-selectable currencies. Costs may be reported for a user-selected year and may be sorted according to various user-selectable criteria. For example, costs may be sorted by teams, subcontractors, or product identification. In addition, forecasted cost reports may be generated for future years. Authorized users may update data in cost report screen 1500 based on updates from subcontractors.

### INDUSTRIAL APPLICABILITY

The disclosed software implemented method for automatically managing a product development has several advantages. For example, the software implemented method includes receiving and storing design data associated with a project. In this manner, a technical link is created among team leaders, designers, analysts, and subcontractors associated with development of a project. Moreover, the disclosed method actively notifies analysts and designers of deadlines for entering design data and defines what design data should be provided (e.g., checklists). Well-defined notifications, such as those disclosed, foster effective communication across organizations and drive project development.

It will be apparent to those skilled in the art that various modifications and variations can be made in the disclosed automatic project management method without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A method for managing development of products including machine components, the method comprising:
opening a record adapted to store design data associated with a machine component;
receiving a first portion of the design data from a designer;
receiving verification of the first portion of the design data from a first analyst;
receiving a second portion of the design data associated with the machine component from the first analyst;
sending the verified first portion of the design data and the second portion of the design data to a second analyst as a work order;
receiving updates from the second analyst on work performed in response to the work order; and
reporting progress on work performed based on the updates.

2. The method of claim 1, further including:
receiving a proposed modification to the work order from the second analyst;
requesting approval of the proposed modification from the first analyst; and
sending an indication to the second analyst of at least one of approval and disapproval of the proposed modification.

3. The method of claim 1, further including:
receiving a third portion of the design data from the designer;
receiving verification of the third portion of the design data from the first analyst;
receiving a fourth portion of the design data associated with the design from the first analyst; and
sending the the verified third portion of the design data and the fourth portion of the design data to the second analyst to supplement the work order.

4. The method of claim 1, wherein the record adapted to store the design data includes a deadline, and the method further includes sending an email reminder to at least one of the designer and the first analyst requesting at least one of entry and verification of data before the deadline.

5. The method of claim 1, wherein the work order instructs the second analyst to perform at least one of finite element meshing and finite element analysis using at least the verified first portion of the design data.

6. The method of claim 5, wherein the finite element analysis is a single iteration analysis based on a previously completed analysis.

7. The method of claim 1, further including:
archiving the record adapted to store the design data and results of work performed in response to the work order.

8. The method of claim 1, wherein reporting progress includes:
providing interfaces for displaying costs, schedules, and statistics associated with development of one or more machine components.

9. The method of claim 1, further including:
automatically changing a status associated with the record based on completion of at least one of entry, verification, and sending of the design data stored in the record;
selectively permitting changes to the record based on the status associated with the record.

10. The method of claim 1, further including:
providing a user interface adapted to create and edit an analyst record and a product record,
wherein the product record includes information describing a product including machine components, and
wherein the analyst record includes information describing the second analyst designated to respond to the work order.

11. A computer readable medium having computer executable instructions for performing a method for managing development of products including machine components, the method comprising:
opening a record adapted to store design data associated with a machine component;
receiving a first portion of the design data from a designer;
receiving verification of the first portion of the design data from a first analyst;
receiving a second portion of the design data associated with the machine component from the first analyst;
sending the verified first portion of the design data and the second portion of the design data to a second analyst as a work order;
receiving updates from the second analyst on work performed in response to the work order; and
reporting progress on work performed based on the updates.

12. The computer readable medium of claim 11, wherein the method further includes:
receiving a proposed modification to the work order from the second analyst;
requesting approval of the proposed modification from the first analyst; and
sending an indication to the second analyst of at least one of approval and disapproval of the proposed modification.

13. The computer readable medium of claim 11, wherein the method further includes:
receiving a third portion of the design data from the designer;
receiving verification of the third portion of the design data from the first analyst;
receiving a fourth portion of the design data associated with the design from the first analyst; and
sending the verified third portion of the design data and the fourth portion of the design data to the second analyst to supplement the work order.

14. The computer readable medium of claim 11, wherein the record adapted to store the design data includes a deadline, and the method further includes sending an email reminder to at least one of the designer and the first analyst requesting at least one of entry and verification of data before the deadline.

15. The computer readable medium of claim 11, wherein the work order instructs the second analyst to perform at least one of finite element meshing and finite element analysis using at least the verified first portion of the design data.

16. The computer readable medium of claim 15, wherein the finite element analysis is a single iteration analysis based on a previously completed analysis.

17. The computer readable medium of claim 11, wherein the method further includes:
archiving the record adapted to store the design data and results of work performed in response to the work order.

18. The computer readable medium of claim 11, wherein reporting progress includes:
providing interfaces for displaying costs, schedules, and statistics associated with development of one or more machine components.

19. The computer readable medium of claim 11, wherein the method further includes:
automatically changing a status associated with the record based on completion of at least one of entry, verification, and sending of the design data stored in the record;
selectively permitting changes to the record based on the status associated with the record.

20. The computer readable medium of claim 11, wherein the method further includes:
providing a user interface adapted to create and edit an analyst record and a product record,
wherein the product record includes information describing a product including machine components, and
wherein the analyst record includes information describing the second analyst designated to respond to the work order.

21. A user interface for managing development of machine components, the user interface providing options for:
creating records adapted to store design data associated with machine components used in a product;
inputting data in the records adapted to store the design data to create work orders;
displaying a status of the records adapted to store the design data;
creating analyst records describing analysts designated to respond to the work orders;
creating product records describing products utilizing the machine components;
displaying statistics describing progress associated with the work orders;
displaying schedules associated with the work orders;
displaying costs associated with the work orders; and
archiving the records adapted to store the design data and results of work performed by the analysts designated to respond to the work orders.
